(19) United States
(12) Patent Application Publication
(10) Pub. No.: US 2007/0235977 A1
(43) Pub. Date: Oct. 11, 2007

(54) MOTORCYCLE FRAME

(76) Inventor: Thomas H. Cleland, Crown Point, IN (US)

Correspondence Address: HARTMAN & HARTMAN, P.C., 552 EAST 700 NORTH, VALPARAISO, IN, 46383, US

(21) Appl. No.: 11/697,793

(22) Filed: Apr. 9, 2007

Related U.S. Application Data
(60) Provisional application No. 60/744,428, filed on Apr. 7, 2006.

(51) Int. Cl. B62K 7/00

(52) U.S. Cl. 280/281.1

(57) ABSTRACT

A motorcycle frame having first, second, and third frame sections. The first frame section is sized and configured to receive and secure a motorcycle engine. The second frame section is located rearwardly from the first frame section, and is sized and configured to receive and secure a motorcycle transmission and support a motorcycle driver seat. The third frame section is located rearwardly from the second frame section, and is sized and configured to support a motorcycle passenger seat forward of a rear tire of the motorcycle.

### CROSS REFERENCE TO RELATED APPLICATIONS

This application claims the benefit of U.S. Provisional Application No. 60/744,428, filed Apr. 7, 2006, the contents of which are incorporated herein by reference.

### BACKGROUND OF THE INVENTION

The present invention generally relates to motorcycles. More particularly, this invention relates to a motorcycle frame that enables a passenger seat to be accommodated in front of the rear wheel of a motorcycle, rather than above the rear wheel.

FIG. 1 schematically represents a conventional frame 10 for a two-wheeled motorcycle (shown in phantom). The frame 10 is represented as having a front section 12 where an engine (not shown) would be ordinarily accommodated, and a rear section 14 immediately behind the front section 12 where a transmission (not shown) is ordinarily accommodated and above which an operator seat (not shown) is mounted. A pair of rear wheel suspension forks 16 is mounted rearward from the rear section 14 and a passenger seat (not shown) is mounted over the rear wheel 18 of the motorcycle. As evident from FIG. 1, in the typical riding position of such a conventional two-wheeled motorcycle, the passenger sits with higher elevation than the operator due to the passenger seat location above the rear wheel 18.

There are a number of disadvantages associated with conventional motorcycle frame configurations of the type shown in FIG. 1. When the passenger is located above the rear wheel 18—that is, with his or her torso extending above the rear wheel 18—the combined center of gravity of the motorcycle and rider (including the passenger) is relatively high. This reduces maneuverability of the motorcycle and increases the tendency to tip over. Furthermore, with the torso of the passenger fully exposed above the motorcycle, wind drag is increased reducing fuel economy. Still further, the passenger is largely exposed so that in the event of an accident, there is a greater tendency for a serious injury.

Accordingly, there is need for motorcycle frames capable of increasing the safety and fuel economy of motorcycles while also enhancing their operational characteristics and comfort.

### BRIEF SUMMARY OF THE INVENTION

The present invention provides a motorcycle frame capable of increasing the safety and fuel economy of a motorcycle while also enhancing its operational characteristics and comfort.

The motorcycle frame generally includes first, second, and third frame sections. The first frame section is sized and configured to receive and secure a motorcycle engine. The second frame section is located rearwardly from the first frame section, and is sized and configured to receive and secure a motorcycle transmission and support a motorcycle driver seat. The third frame section is located rearwardly from the second frame section, and is sized and configured to support a motorcycle passenger seat forward of a rear tire of the motorcycle.

In view of the above, it can be seen that the motorcycle frame of this invention is capable of increasing the safety and fuel economy of a motorcycle while also enhancing its operational characteristics and comfort by locating the passenger seat in front of the rear wheel, rather than above the rear wheel. By accommodating the passenger in front of the rear wheel, additional space is created under the passenger seat that may have a broad range of uses.

Other objects and advantages of this invention will be better appreciated from the following detailed description.

### BRIEF DESCRIPTION OF THE DRAWINGS

FIG. 1 schematically represents a side view of a motorcycle frame in accordance with the prior art.

FIGS. 2 and 3 schematically represent side and top views of a motorcycle frame in accordance with an embodiment of this invention.

FIG. 4 schematically represents an isolated top view of a frame extension of the motorcycle frame of FIGS. 2 and 3.

### DETAILED DESCRIPTION OF THE INVENTION

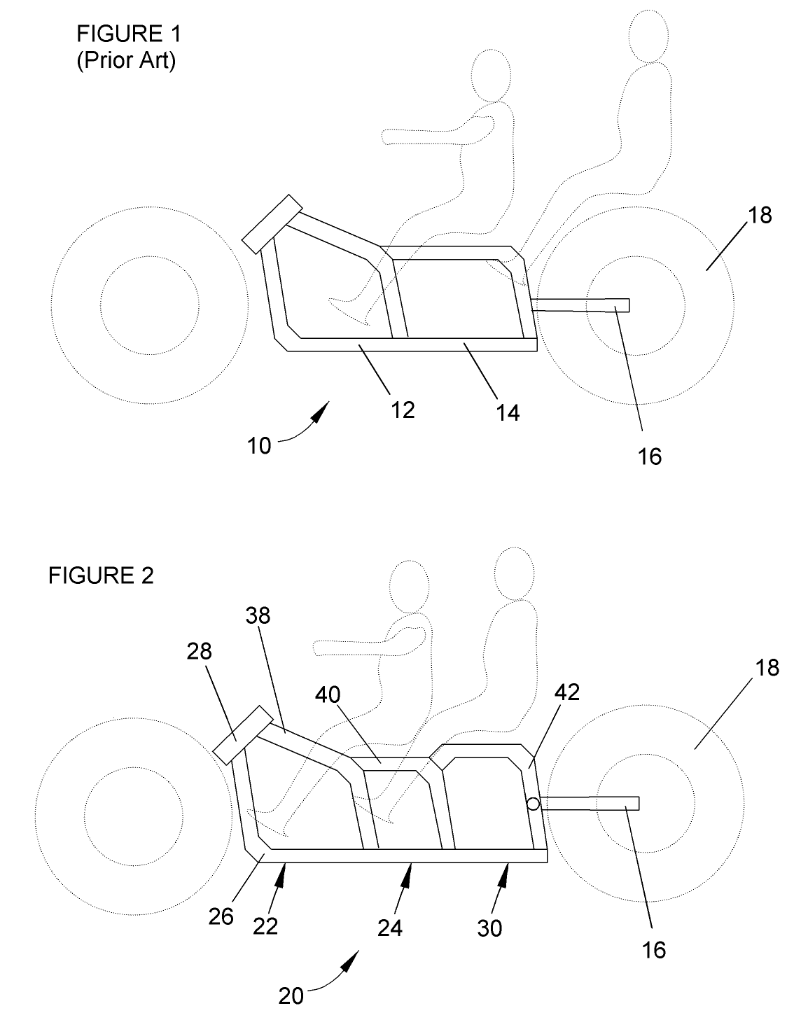

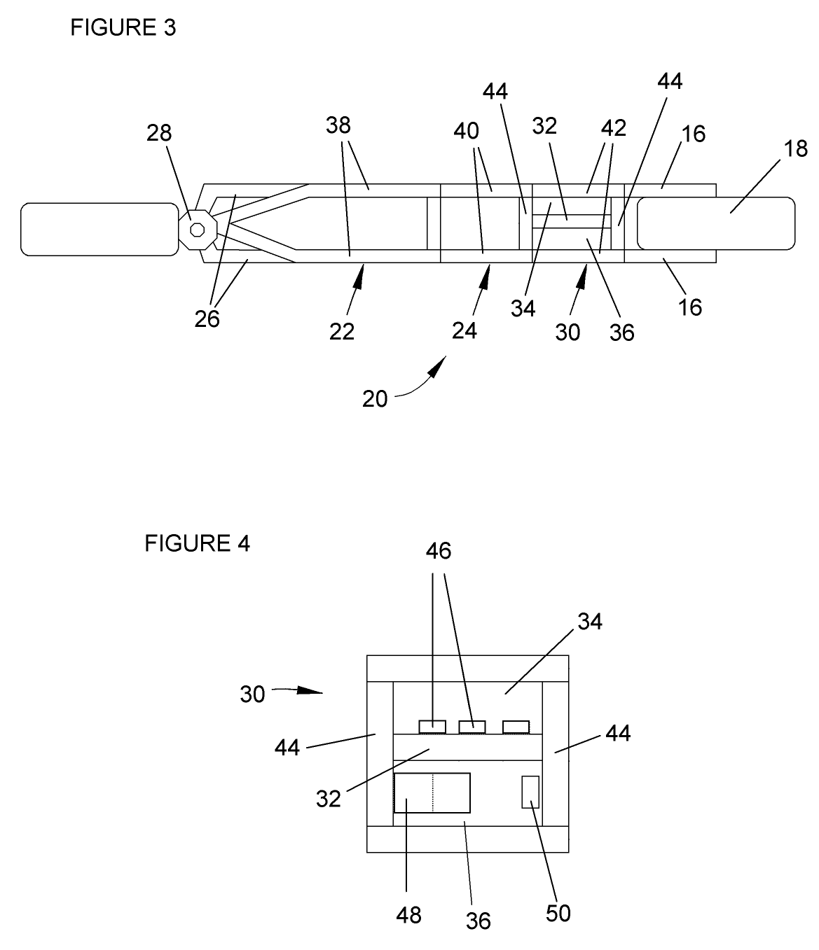

FIGS. 2 and 3 schematically represent a motorcycle frame 20 configured to increase the safety and fuel economy of a motorcycle (shown in phantom), while also enhancing the operational characteristics and comfort of the motorcycle. The frame 20 achieves this preferred aspect of the invention by locating the passenger seat in front of the rear wheel 18 as seen in FIG. 2, rather than above the rear wheel 18 as seen in FIG. 1. By accommodating the passenger in front of the rear wheel 18, additional space is created under the passenger seat which may have a broad range of uses, as represented in FIGS. 3 and 4.

To accomplish the above, the motorcycle frame 20 is extended by the inclusion of a frame section 30, which is in addition to a front frame section 22 where the motorcycle engine (not shown) is ordinarily accommodated and a frame section 24 immediately behind the front frame section 22 and where the motorcycle transmission (not shown) is ordinarily accommodated. The additional frame section 30 is located within the frame 20 between the transmission frame section 24 and the rear wheel suspension forks 16, the latter of which may be pivotally attached to the frame section 30. As evident from FIG. 2, the frame section 30 is able to accommodate a passenger seat, which may be a discrete seat or part of the driver seat on the transmission frame section 24. As evident from FIG. 2, the frame section 30 locates the passenger seat in front of the rear wheel 18, instead of above the rear wheel 18 as done conventionally (e.g., FIG. 1). FIG. 4, which schematically represents an isolated top view of the additional frame section 30, shows how the section 30 may be advantageously divided with a partition 32 into compartments 34 and 36.

As is generally conventional, the front (or engine) section 22 of the frame 20 is represented as including two lower tubular members 26 welded (or otherwise attached) to a lower portion of a neck 28, and extending downwardly and rearwardly while diverging from one another. The engine section 22 further includes two upper tubular members 38 welded (or otherwise attached) to the upper portion of the neck 286. The upper tubular members 38 extend rearwardly while also diverging from one another, and are welded (or otherwise attached) to the lower tubular members 26 to generally define the engine section 22, as seen in FIG. 2.

The transmission frame section 24 is also represented as including two upper tubular members 40 welded (or otherwise attached) to portions of the upper tubular members 28. The tubular members 40 extend rearwardly and then downwardly, and are welded (or otherwise attached) to rearward potions of the lower tubular members 26. As previously noted, principal functions of the transmission section 24 are to provide a support structure for the driver seat and house the motorcycle transmission (not shown).

The additional frame section 30 of this invention is schematically represented as including two upper tubular members 42 welded (or otherwise attached) to upper portions of the upper tubular members 40. The tubular members 42 extend rearwardly and then downwardly, where they are welded to rearward portions of the lower tubular members 26.

As evident from FIG. 2, a notable function of the frame section 30 is to accommodate and support the passenger seat in front of the rear wheel 18. Additional benefits include the ability to provide additional storage space, shown in FIGS. 3 and 4 as being divided into two separate compartments 34 and 36 by the partition 32, such as a wall or plate oriented vertically within the section 30. FIGS. 3 and 4 represent the frame section 30 as further including spacers 44 to laterally brace the frame section 30.

The partition 32 is represented as welded or otherwise attached to the spacers 44. In addition to providing structural reinforcement, the partition 32 can also serve as structure for mounting for various electrical and mechanical components of the motorcycle, such as rectifiers and circuit breakers 46, a battery 48, and an air pump 50.

In FIG. 2, the position of a passenger is seen in relation to the frame section 30. Relative to the conventional frame 10 of FIG. 1, the passenger is lowered in front of the rear wheel 18 in relation to the prior art frame of FIG. 1. The inclusion of the frame section 30 is notably advantageous because it lowers the combined center of gravity of the motorcycle and its riders, including the passenger, to permit better operational and handling performance. In addition, accommodating the passenger seat on the frame section 30 in front of the rear wheel 18 provides the additional advantage of reducing wind drag that results from a passenger sitting on a passenger seat located above the rear wheel 18, as evident from FIG. 1. Finally, the separate storage compartments 34 and 36 with the frame section 30 provide the advantage of keeping electrical and mechanical devices separate and farther from the engine to reduce the heating effect of the engine.

While the invention has been described in terms of a specific embodiment, it is apparent that other forms could be adopted by one skilled in the art. For example, the physical configuration of the frame 20 and its individually sections 22, 24, and 30 could and likely would differ significantly from that schematically represented in FIGS. 2, 3, and 4, and various materials and processes could be used to fabricate the frame 20. Furthermore, while the sections 22, 24, and 30 of the frame 20 are represented and described as being individually constructed and then assembled together, it is foreseeable that one or more of the sections 22, 24, and 30 could be molded or otherwise fabricated as a single unit, such that the entire frame 20 could have a more integrated construction. Therefore, the scope of the invention is to be limited only by the following claims.

1. A motorcycle frame comprising:
a first frame section sized and configured to receive and secure a motorcycle engine;
a second frame section located rearwardly from the first frame section, the second frame section being sized and configured to receive and secure a motorcycle transmission and support a motorcycle driver seat; and
a third frame section located rearwardly from the second frame section, the third frame section being sized and configured to support a motorcycle passenger seat forward of a motorcycle rear tire.

2. The motorcycle frame according to claim 1, further comprising rear fork members extending rearwardly from the third frame section.

3. The motorcycle frame according to claim 2, wherein the rear fork members are pivotally attached to the third frame section.

4. The motorcycle frame according to claim 1, wherein a motorcycle engine is received and secured within the first frame section.

5. The motorcycle frame according to claim 1, wherein a motorcycle transmission is received and secured within the second frame section.

6. The motorcycle frame according to claim 1, wherein a motorcycle driver seat is mounted and supported on the second frame section.

7. The motorcycle frame according to claim 1, further comprising a storage compartment within the third frame section.

8. The motorcycle frame according to claim 1, wherein a motorcycle passenger seat is mounted and supported on the third frame section.

9. The motorcycle frame according to claim 1, wherein the third frame section is attached to the first and second frame sections.

10. The motorcycle frame according to claim 1, further comprising at least one partition within the third frame section, the partition dividing an interior of the third frame section so as to define at least two compartments within the third frame section.

11. The motorcycle frame according to claim 10, further comprising electrical and mechanical motorcycle components stored within the compartments.

12. A motorcycle frame within a motorcycle, the frame comprising:
a first frame section in which a motorcycle engine is received and secured;
a second frame section located rearwardly from the first frame section and in which a motorcycle transmission is received and secured on which a motorcycle driver seat is mounted and supported;
a third frame section located rearwardly from the second frame section, the third frame section containing a storage compartment and supporting a motorcycle passenger seat; and
rear fork members extending rearwardly from the third frame section, wherein the motorcycle passenger seat is forward and not above a rear tire mounted to the rear fork members.

13. The motorcycle frame according to claim 12, wherein the rear fork members are pivotally attached to the third frame section.

14. The motorcycle frame according to claim 12, wherein the third frame section is attached to the first and second frame sections.

15. The motorcycle frame according to claim 12, further comprising at least one partition within the third frame section, the partition dividing an interior of the third frame section so as to define at least two compartments within the third frame section.

16. The motorcycle frame according to claim 15, further comprising electrical and mechanical motorcycle components stored within the compartments.
